(19) United States
(12) Patent Application Publication
(10) Pub. No.: US 2019/0152581 A1
(43) Pub. Date: May 23, 2019

(54) Actuator for Adaptive Airfoil

(71) Applicant: Aviation Partners, Inc., Seattle, WA (US)

(72) Inventor: Edward Davis, Seattle, WA (US)

(21) Appl. No.: 16/091,424

(22) PCT Filed: Mar. 31, 2017
(86) PCT No.: PCT/US17/25375

§ 371 Date: Oct. 4, 2018

(51) Int. Cl. B64C 9/18; B64C 9/02; B64C 13/30

(52) U.S. Cl. CPC B64C 9/18; B64C 13/30; B64C 9/02

(57) ABSTRACT

An apparatus and method for an actuator system to modify an adaptive flap of an aircraft wing. The system may include a drive rod extending from a nose portion of the flap to an interior thereof. A bell crank may be attached to the interior and configured to receive an end of the drive rod. A pivot disposed opposite of the drive rod may couple the bell crank to a mount fixed to a lower surface of a trailing edge portion of the flap. A skin overlap may be configured to allow the lower surface of the trailing edge portion to slide adjacent to a lower surface of a remaining portion of the flap under the action of the drive rod. A bumper may be disposed within the aircraft wing and configured to exert a continuous force on the drive rod when the flap is moved to a retracted state.

### PRIORITY

This application claims priority to U.S. Provisional Application No. 62/318,132, filed Apr. 4, 2016, titled “Actuator For Adaptive Airfoil,” and incorporated by reference in its entirety herein.

### FIELD

The field of the present disclosure generally relates to aeronautical vehicle systems. More particularly, the field of the invention relates to a system and method for altering the shape of an airfoil.

### BACKGROUND

Current aircraft designs utilize a variety of airfoils on wings, horizontal stabilizers, canards, rotor blades, vertical stabilizers, and a variety of other structures consisting primarily of relatively fixed airfoil surfaces. Flying surfaces generally must be optimized for specific applications such as low-speed handling or improved high-speed aerodynamics. Aircraft configured to operate in several performance environments must often adopt airfoil surfaces that provide suitable characteristics in multiple environments. Such a compromise, however, typically diminishes the overall performance of the aircraft, as well as diminishing performance in specific flight conditions.

Conventional configurations often limit modification of the flying surfaces to that which may be achieved by way of mechanical moving surfaces. Mechanical actuators and linkage systems are utilized to effectuate changes in the airfoil surfaces to allow for enhanced low-speed flight and limited autopilot maneuvering. Military aircraft have utilized mechanically swept wings for improved aerodynamics during high speed flight. Although movable airfoil components may have a substantial effect on the aerodynamic flight characteristics of the airfoil, the shapes of the airfoil components generally are fixed. As such, further optimizing airfoils for performance over a larger range of the flight envelope typically requires incorporating additional airfoil components as well as all those certain components necessary to move the additional airfoil components. Including additional moveable airfoil components tends to be unappealing, however, due limited space and weight requirements associated with most aircraft.

Shape adaptive airfoils are an improved approach whereby the configuration of the airfoil may be optimized throughout the flight envelope of the aircraft. Modifying the shape of the airfoil enables the configuration of the airfoil to be optimized over most of the flight conditions of the aircraft. An optimized airfoil may provide better lift characteristics at lower speeds to allow greater take-off weight while providing lower drag at high speed to achieve a greater flight range. Thus, a modifiable airfoil capable of being optimized throughout the flight envelope provides significant improvements to aircraft performance.

A modifiable or adaptive airfoil generally requires a means of actuation. A drawback, however, is that conventional electric or hydraulic actuators tend to be heavy, complex, and difficult to fit within the confines of the adaptive airfoil. Further, conventional actuators generally require electrical signal wires, power wires or hydraulic lines, and complex controllers. Routing of wiring and hydraulic lines tends to be is difficult to accomplish on movable structures, particularly when Fowler action is required. Moreover, conventional actuators often are expensive, custom design items that require long lead times for development to ensure that the actuators meet all strength, deflection, fatigue, and mounting requirements.

What is needed, therefore, is an actuation system configured to modify adaptive airfoils and cooperate with existing flap or slat drive systems and linkage systems.

### SUMMARY

An apparatus and method are provided for an actuator system for modifying a shape of an airfoil. The actuator system comprises a skin overlap that is disposed on a surface of the airfoil. The skin overlap is configured to allow a first portion of the airfoil to move relative to a second portion of the airfoil. A drive rod is coupled with a bell crank that is pivotally attached to an interior of the first portion of the airfoil. A bumper is configured to push the drive rod during movement of the airfoil, such that the bell crank slides the first portion relative to the second portion, thereby modifying the shape of the airfoil. The actuator system may be coupled with, and driven by, a flap drive system and a linkage system that are configured to extend, deflect, and retract a trailing edge flap of an aircraft. In some embodiments, the actuator system may be configured to cooperate with a slat drive system and a linkage system that are configured to extend a slat of an aircraft. In some embodiments, the actuator system may be configured to cooperate with a hinged airfoil member, such that rotation of the hinged airfoil member pushes the drive rod, thereby effectuating a shape adaptation of the airfoil member. The hinged airfoil member may be comprised of ailerons, horizontal stabilizers, and any of various other generally hinged airfoil members of an aircraft.

In an exemplary embodiment, an actuator system for modifying a shape of an airfoil comprises a skin overlap disposed on a surface of the airfoil and configured to allow a first portion to move relative to a second portion of the airfoil; a drive rod coupled with a mount affixed to an interior of the first portion; and a bumper configured to push the drive rod and the mount during movement of the airfoil, such that the first portion slides relative to the second portion, thereby modifying the shape of the airfoil.

In another exemplary embodiment, the airfoil comprises a trailing edge flap coupled with an aircraft wing, the bumper being mounted to the aircraft wing so as to push the drive rod when the flap is retracted, thereby changing the airfoil from an initial profile to a cambered profile. In another exemplary embodiment, the skin overlap is disposed on an upper surface of the trailing edge flap, and wherein the lower surface of the trailing edge flap is configured to exert a continuous force in opposition to the force exerted by the drive rod while the airfoil is in the cambered profile. In another exemplary embodiment, the skin overlap is disposed on a lower surface of the trailing edge flap, and wherein the upper surface of the trailing edge flap is configured to exert a continuous force in opposition to the force exerted by the drive rod while the airfoil is in the cambered profile. In another exemplary embodiment, the continuous force changes the trailing edge flap from the cambered profile to the initial profile during extending of the trailing edge flap.

In another exemplary embodiment, a bell crank is rotatably attached to an interior member of the airfoil and configured to receive an end of the drive rod, and wherein a pivot is disposed opposite of the drive rod and configured to couple the bell crank to the mount. In another exemplary embodiment, the actuator system is coupled with and driven by a flap drive system and a linkage system configured to extend, deflect, and retract a trailing edge flap of an aircraft. In another exemplary embodiment, the actuator system is configured to cooperate with a slat drive system and a linkage system that are configured to extend a slat of an aircraft. In another exemplary embodiment, the actuator system is configured to couple the drive rod adjacently to hinges of an airfoil member, such that rotation of the airfoil member about the hinges pushes the drive rod, thereby effectuating a shape adaptation of the airfoil member. In another exemplary embodiment, the airfoil member may be comprised of ailerons, horizontal stabilizers, and any of various other generally hinged airfoil members of an aircraft.

In an exemplary embodiment, a method for an actuator system to modify a shape of an airfoil comprises configuring a skin overlap on a surface of the airfoil to allow a first portion to move relative to a second portion of the airfoil; coupling a drive rod with a mount affixed to an interior of the first portion; and positioning a bumper to push the drive rod and the mount during movement of the airfoil, such that the first portion slides relative to the second portion, thereby modifying a profile of the airfoil.

In another exemplary embodiment, coupling comprises attaching a bell crank to an interior member of the airfoil, such that an end of the drive rod is received by the bell crank, and wherein coupling comprises linking the bell crank to the mount by way of a pivot disposed oppositely of the end of the drive rod. In another exemplary embodiment, configuring comprises forming the skin overlap in a lower surface of a tailing edge flap such that a continuous force exerted by the drive rod modifies a camber profile of the trailing edge flap by way of the bell crank and the mount, and wherein an upper surface of the trailing edge flap is configured to exert a continuous force in opposition to the force exerted by the drive rod. In another exemplary embodiment, positioning comprises mounting the bumper near the airfoil, such that the drive rod contacts the bumper during retracting of the airfoil.

In another exemplary embodiment, configuring comprises forming the skin overlap in an upper surface of a trailing edge flap such that a continuous force exerted by the drive rod modifies a camber profile of the trailing edge flap, and wherein a lower surface of the trailing edge flap is configured to exert a continuous force in opposition to the force exerted by the drive rod. In another exemplary embodiment, the method further comprises coupling the actuator system with a flap drive system and a linkage system that are configured to extend, deflect, and retract a trailing edge flap of an aircraft. In another exemplary embodiment, the method further comprises coupling the actuator system with a slat drive system and a linkage system that are configured to extend a slat of an aircraft.

In an exemplary embodiment, an actuator system for modifying a trailing edge portion of a flap of an aircraft wing comprises a drive rod extending from a nose portion of the flap to an interior of the flap; a bell crank rotatably attached to an interior member of the flap and configured to receive an end of the drive rod; a pivot disposed opposite of the drive rod and configured to couple the bell crank to a mount fixed to a lower surface of the trailing edge portion; a skin overlap configured to allow the lower surface of the trailing edge portion to slide adjacently to a lower surface of a remaining portion of the flap under the action of the drive rod; and a bumper disposed within the aircraft wing and configured to exert a continuous force on the drive rod when the flap is moved to a retracted state.

In another exemplary embodiment, the actuator system is configured to cooperate with a flap drive system and a linkage system that are configured to extend, deflect, and retract the flap of the aircraft wing. In another exemplary embodiment, the continuous force maintains a cambered profile of the trailing edge portion when the flap is in the retracted state. In another exemplary embodiment, the continuous force is relieved and the trailing edge portion returns to an initial profile when the flap is extended away from the aircraft wing.

### BRIEF DESCRIPTION OF THE DRAWINGS

The drawings refer to embodiments of the present disclosure in which:

FIG. 1 illustrates a perspective view of an exemplary aircraft suitable for implementation of an actuator system for modifying the shape of flaps in accordance with the present disclosure;

FIG. 2A illustrates a cross-sectional view of an exemplary flap drive system comprised of an exemplary linkage system that is orienting a flap in a position suitable for cruising of the aircraft, according to the present disclosure;

FIG. 2B illustrates a cross-sectional view of the exemplary flap drive system of FIG. 2A that is orienting the flap in a position suitable for takeoff of the aircraft, in accordance with the present disclosure;

FIG. 2C illustrates a cross-sectional view of the exemplary flap drive system of FIG. 2A that is orienting the flap in a position suitable for landing of the aircraft in accordance with the present disclosure;

FIG. 3A illustrates a cross-sectional view of an exemplary actuator system for modifying the shape of a trailing edge of the flap, according to the present disclosure;

FIG. 3B illustrates a cross-sectional view of the exemplary actuator system of FIG. 3A with the flap in a retracted state and the shape of the trailing edge suitably modified, according to the present disclosure; and

FIG. 4 illustrates a close-up cross-sectional view of an embodiment of an actuator system coupled with an upper surface of a flap and configured to adapt the shape of the trailing edge of the flap, in accordance with the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first wing,” may be made. However, the specific numeric reference should not be interpreted as a literal sequential order but rather interpreted that the “first wing” is different than a “second wing.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and method for an actuator system to modify the shape of an adaptive airfoil. The actuator system comprises a skin overlap, or a skin break, disposed on a surface of the airfoil and is configured to allow a first portion to move relative to a second portion of the airfoil. A drive rod is coupled with a mount that is affixed to an interior of the first portion. A bumper is configured to push the drive rod and the mount during retracting of the airfoil, such that the first portion slides relative to the second portion, thereby modifying the shape of the airfoil. In some embodiments, the airfoil may comprise a trailing edge flap coupled with an aircraft wing, and the bumper may be mounted within the aircraft wing so as to push the drive rod when the flap retracts, thereby changing the airfoil from an initial profile to a cambered profile. The actuator system may be configured to cooperate with a flap drive system and a linkage system that are configured to extend, deflect, and retract the tailing edge flap of the aircraft wing.

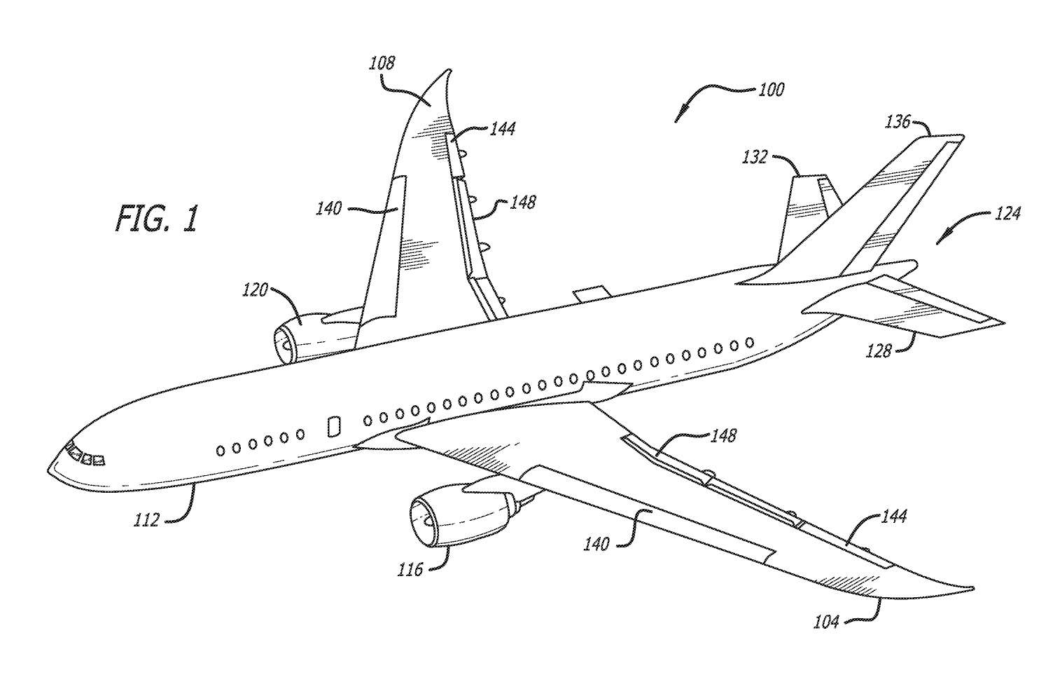

FIG. 1 illustrates a perspective view of an exemplary aircraft suitable for implementation of an actuator system for modifying the shape of flaps in accordance with the present disclosure. The aircraft 100 comprises a first wing 104 and a second wing 108 attached to a body 112. An engine 116 is coupled with the first wing 104, and an engine 120 is coupled with the second wing 108. The body 112 includes a tail section 124 that is comprised of a first horizontal stabilizer 128, a second horizontal stabilizer 132, and a vertical stabilizer 136.

It should be understood that the illustration of the aircraft 100 in FIG. 1 is not meant to imply physical or architectural limitations to the manner in which an illustrative configuration may be implemented. For example, although the aircraft 100 is a commercial aircraft, in other embodiments the aircraft 100 may be a military aircraft, rotorcraft, helicopter, unmanned aerial vehicle, spaceplane, or any other suitable aircraft.

Moreover, although the illustrative examples for an exemplary embodiment are described with respect to an aircraft, an illustrative embodiment may be applied to other types of platforms. The platform may be, for example, a mobile platform, a stationary platform, a land-based structure, an aquatic-based structure, and a space-based structure. More specifically, the platform, may be a surface ship, a train, a spacecraft, a submarine, an automobile, a power plant, a windmill, a manufacturing facility, a building, and other suitable platforms configured to interact with exterior fluids such as atmospheric air or water.

As shown in FIG. 1, slats 140 are disposed along a leading edge of the first and second wings 104, 108. The slats 140 generally enable a pilot to alter the performance characteristics of the aircraft 100 by manipulating the nose camber of the wings 104, 108. In some embodiments, however, leading edge devices other than the slats 140 may be incorporated into the aircraft 100. For example, leading edge devices may include fixed slots, nose flaps, Kruger flaps, cuffs, and other similar devices. In general, the slats 140 extend the leading edge of the wings 104, 108 forward and downward, thereby keeping air flowing over the wings at slower speeds.

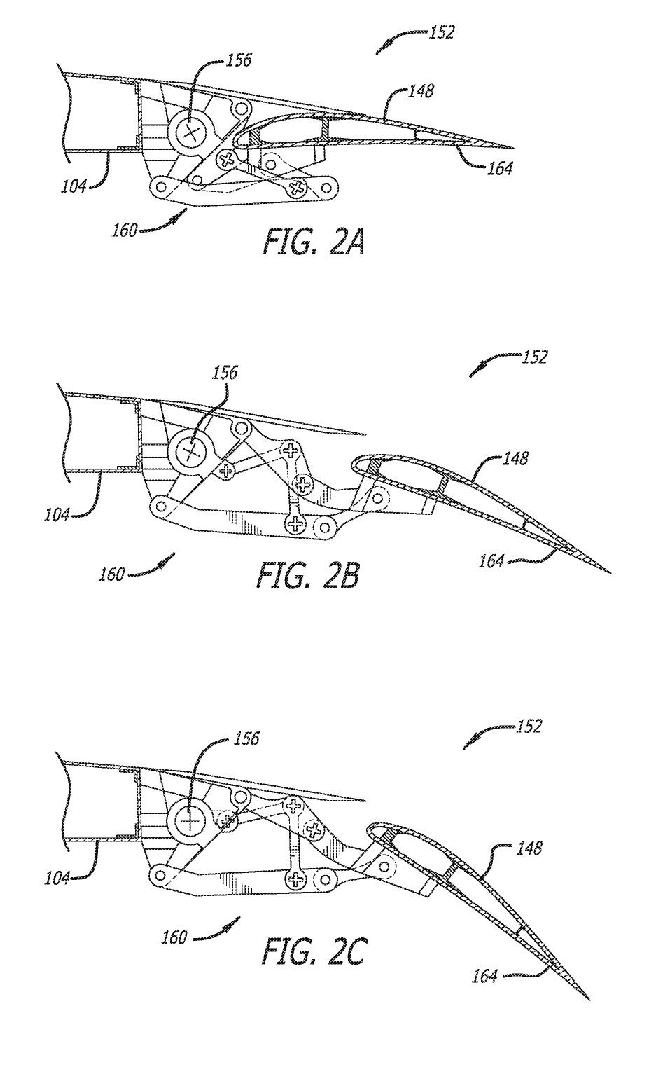

Coupled with a trailing edge of each of the first and second wings 104, 108 are ailerons 144 and trailing edge flaps 148. As will be appreciated, the ailerons 144 enable the pilot to control rolling of the aircraft 100. The trailing edge flaps 148 preferably are of the Fowler variety that enable the pilot to manipulate the performance of the aircraft 100 by altering the camber and cord of the first and second wings 104, 108, as best shown in FIGS. 2A-2C.

FIGS. 2A-2C illustrate cross-sectional views of an exemplary flap drive system 152 that may be disposed within the first and second wings 104, 108. Although only the first wing 104 is specifically discussed below in connection with FIGS. 2A-2C, it should be understood that substantially identical structures and mechanisms are to be disposed within the second wing 108, as well. The flap drive system 152 is comprised of a rotary actuator 156 and a linkage system 160 that are configured to extend, deflect, and retract the trailing edge flap 148 according to signals received from the pilot. FIG. 2A shows the trailing edge flap 148 in a fully retracted state with substantially minimal deflection. Those skilled in the art will recognize that the orientation of the trailing edge flap 148 illustrated in FIG. 2A is best suited for cruising of the aircraft 100. FIG. 2B illustrates the trailing edge flap 148 extended and deflected to a degree suitable for takeoff of the aircraft 100. As shown in FIG. 2C, further extending and deflecting of the tailing edge flap 148 places the flap in an orientation suitable for landing the aircraft 100.

Upon comparing the trailing edge flap 148 illustrated in FIGS. 2A-2C, it is straightforward to see that the camber and cord of the tailing edge flap 148 remain unchanged throughout the movement of the flap. In some embodiments, however, it may be advantageous to change at least the camber of the trailing edge flap 148, such as by manipulating a trailing edge portion 164 of the flap. It has been found to be particularly beneficial to adapt the camber of the trailing edge flap 148 when the flap is in the fully retracted state shown in FIG. 2A. It should be understood, however, that such camber changes are not intended to be limited to the trailing edge flap 148, but rather the camber and chord of various other airfoil portions of the aircraft 100 may also be manipulated as discussed herein. For example, in some embodiments, the shape of the slats 140 may be manipulated so as to achieve performance benefits that are unattainable by merely moving the slats 140 as discussed above.

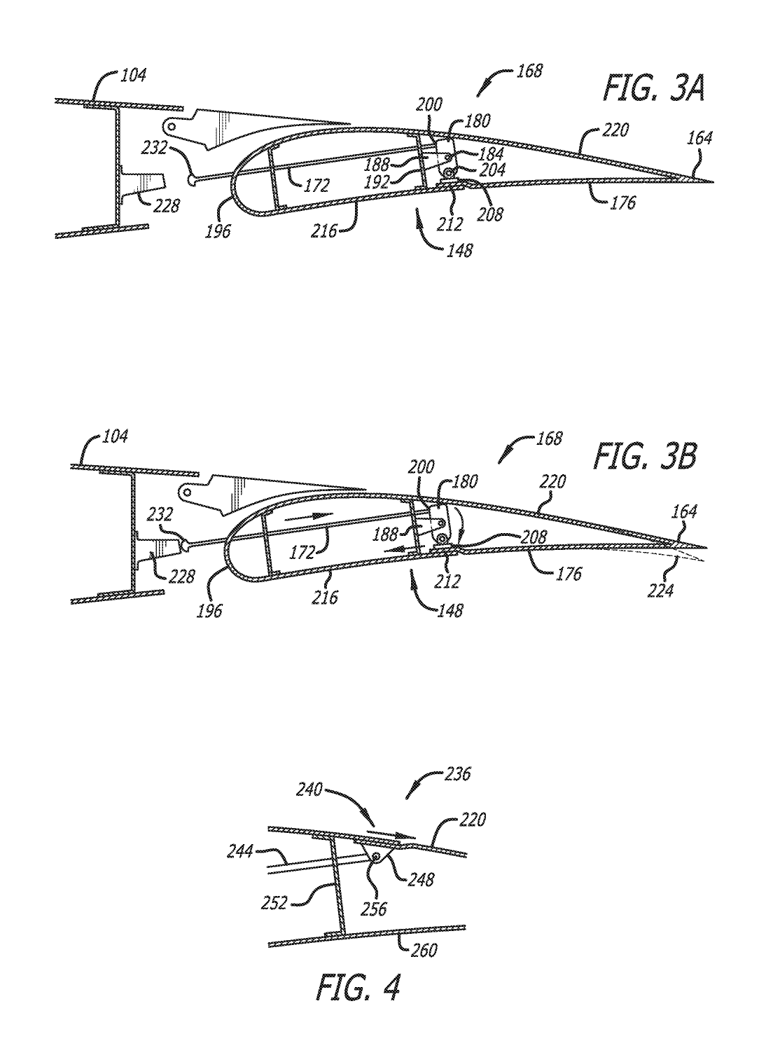

FIGS. 3A and 3B illustrate cross-sectional views of an exemplary embodiment of an actuator system 168 for modifying the shape of the trailing edge portion 164 of the flap 148, according to the present disclosure. For the sake of clarity, the flap drive system 152 and the linkage system 160 are not shown in FIGS. 3A and 3B. It is contemplated, however, that the actuator system 168 illustrated in FIGS. 3A and 3B may be coupled with and driven by the flap drive system 152 and the linkage system 160 without an introduction of any additional actuators, controllers, sensors, electrical wires, or hydraulic lines beyond those required to extend, deflect, and retract the trailing edge flaps 148, as described above with respect to FIGS. 2A-2C.

As shown in FIG. 3A, the actuator system 168 is comprised of a drive rod 172 that is coupled with a lower surface 176 of the trailing edge portion 164 by way of a bell crank 180. A pivot 184 rotatably attaches the bell crank 180 to a stud 188 that is fixed to an interior member 192 of the flap 148. The drive rod 172 extends from outside a nose portion 196 of the flap 148 to a pushrod connection 200 with the bell crank 180, such that moving the drive rod 172 rotates the bell crank 180 about the pivot 184. The pushrod connection 200 may be comprised of any suitable connection, such as, by way of non-limiting example, a pivot, a ball joint, a recess within the bell crank 180 that receives an end of the drive rod 172, or any other similar mechanical connection. A pivot 204 opposite of the pushrod connection 200 couples the bell crank 180 with a mount 208 that is fixed to the lower surface 176 of the trailing edge portion 164. As will be appreciated, the mount 208 may be affixed to the lower surface 176 by way of suitable welds, any of various suitable fasteners, or other aircraft-specific connections.

FIG. 3B illustrates the trailing edge flap 148 moved into a retracted state. When the flap 148 retracts, a rounded end 232 of the drive rod 172, extending beyond the nose portion 196, contacts a bumper 228 mounted within the wing 104, thereby pushing the drive rod 172 toward the trailing edge portion 164. As shown in FIG. 3B, moving the drive rod 172 toward the trailing edge portion 164 rotates the bell crank 180 about the pivot 184, pushing the mount 208 and the lower surface 176 toward the nose portion 196. A skin overlap 212 allows the lower surface 176 of the trailing edge portion 164 to slide over a lower surface 216 of the flap 148. Flexibility of an upper surface 220 of the flap 148 allows the mount 208 to pull the trailing edge portion 164 from an initial profile, shown in FIG. 3A, into a cambered profile 224, as shown in FIG. 3B.

As will be appreciated, the portions of the lower surfaces 176, 216 comprising the skin overlap 212 preferably are in sliding contact, whereby the lower surface 176 passes over the lower surface 216 and extends into the interior of the flap 148. In some embodiments, however, the skin overlap 212 may be comprised of a skin break or a skin gap. It is contemplated, therefore, that in some embodiments, edges of the lower surfaces 176, 216 may not share a sliding relationship, but rather may be moved adjacently to one another so as to allow the mount 208 to pull the trailing edge portion 164 into the cambered profile 224, as described above.

It is contemplated that the bumper 228 may be attached to a variety of structures within the wing 104, such as, by way of non-limiting example, a wing spar, skin overhang, flap track or linkage, or a fitting specifically configured to receive the bumper 228. In some embodiments, however, the bumper 228 may be comprised of any fixed attach point suitable for contacting the drive rod 172, without limitation. Further, the drive rod 172 is not limited to contacting the bumper 228 by way of the rounded end 232. It is envisioned that the bumper 228 and the rounded end 232 may be implemented in a variety of configurations suitable for pushing the drive rod 172 toward the trailing edge portion 164 when the flap 148 is retracted into the wing 104.

As will be recognized, the flexibility of the upper surface 220 operates as a spring, storing elastic potential energy and exerting a continuous force in opposition to the force exerted by the drive rod 172 while the trailing edge portion 164 is in the cambered profile 224. Upon extending the flap 148, as shown in FIG. 3A, and thereby removing the drive rod 172 from the bumper 228, the upper surface 220 pulls the lower surface 176 and the mount 208 away from the nose portion 196, allowing the trailing edge portion 164 to return to the initial profile shown in FIG. 3A. It should be recognized, therefore, that the elastic potential energy stored in the upper surface 220 provides the entirety of the force required to return the trailing edge portion 164 to the initial profile in absence of any additional force-producing devices, such as, springs, hydraulic or electric actuators, and the like.

As will be appreciated, the actuator system 168 need not be limited to the bell crank 180. It is contemplated that any of various structures, or combinations of structures, such as, for example, one or more linkages, may be implemented such that the mount 208 moves desirably when the bumper 228 pushes the drive rod 172. Further, the actuator system 168 is not limited to pulling the trailing edge portion 164 downward into the cambered profile 224, but rather in some embodiments the actuator system 168 may be configured to push the trailing edge portion 164 into an upward cambered profile, without limitation.

Moreover, although in the embodiment of the actuator system 168 illustrated in FIGS. 3A and 3B, the mount 208 is fastened to, and moves the lower surface 176, in other embodiments a suitable mount may be coupled with the upper surface 220. For example, FIG. 4 illustrates a close-up cross-sectional view of an embodiment of an actuator system 236 for modifying the shape of the flap 148 by way of a skin overlap 240 disposed in the upper surface 220. The actuator system 236 is comprised of a drive rod 244 that is coupled to the upper surface 220 by way of a mount 248. The mount 248 may be affixed to the upper surface 220 by way of suitable welds, any of various suitable fasteners, or other aircraft-specific connections. The drive rod 244 is substantially similar to the drive rod 172, illustrated in FIGS. 3A-3B, with the exception that the drive rod 244 is rotatably coupled to the mount 248 by way of a pivot 256. The coupling of the drive rod 244 and the mount 248 may be accomplished by way of any suitable connection, such as, by way of non-limiting example, the pivot 256, a ball joint, a recess within the mount 248 that receives an end of the drive rod 244, or any other similar mechanical connection. Further, in the embodiment of FIG. 4, a lower surface 260 of the flap 148 is comprised of a continuous surface member, in absence of the skin overlap 212, and thus operates as a planar spring that stores elastic potential energy and exerts a continuous force in opposition to the force exerted by the drive rod 244.

During operation of the actuator system 236, when the flap 148 retracts, as discussed in connection with FIG. 3B, the bumper 228 contacts the rounded end 232 and pushes the drive rod 244 toward the mount 248. The skin overlap 240 allows the mount 248 to push the upper surface 220 away from the nose portion 196, thereby changing the trailing edge portion 164 from the initial profile, shown in FIG. 3A, to the cambered profile 224 shown in FIG. 3B. Similar to the actuator system 168, upon extending the flap 148, the drive rod 244 no longer contacts the bumper 228 and the continuous force exerted by the lower surface 260 compresses the skin overlap 240, thereby returning the trailing edge portion 164 to the initial profile illustrated in FIG. 3A. As will be appreciated, the elastic potential energy stored in the lower surface 260 provides the entirety of the force required to return the trailing edge portion 164 to the initial profile in absence of any additional force-producing devices, such as, springs, hydraulic or electric actuators, and the like.

It should be understood that the actuator system 236 is not to be limited to pushing the trailing edge portion 164 into the cambered profile 224, but rather in some embodiments the drive rod 244 may be configured to pull the mount 248 so as to further compress the skin overlap 240 and draw the trailing edge portion 164 into an upward cambered profile. Further, it should be recognized that the degree to which the camber of the trailing edge portion 164 may be changed is determined, at least in part, by the length of the drive rod 244. As such, the length of the drive rod 244 is not to be limited to specific lengths, nor is the trailing edge portion 164 to be limited to specific cambered profiles, but rather any suitable length of the drive rod 244 may be implemented so as to change the trailing edge portion 164 into any desired cambered profile, without limitation, and without deviating beyond the spirit and scope of the present disclosure.

Moreover, it is contemplated that either of the actuator systems 168, 236 may be coupled with airfoil members other than trailing edge flaps 148, such as, by way of non-limiting example, the ailerons 144, the first horizontal stabilizer 128, the second horizontal stabilizer 132, as well as any of various other generally hinged airfoil members comprising the aircraft 100. For example, in some embodiments, either of the drive rods 172, 244 may be coupled adjacently to hinges of a hinged airfoil member, such that rotation of the airfoil member about the hinges pushes the drive rod, as described herein, thereby effectuating a shape adaptation of the airfoil member.

It is contemplated that the drive rods 172, 244 need not be limited to generally solid, elongate members, as described above, but rather the drive rods 172, 244 may be comprised any of various devices, or combinations of devices, that are suitable for exerting forces on the mounts 208, 248 so as to effectuate shape adaptations of airfoil members, such as the trailing edge flap 148. In some exemplary embodiments, the drive rods 172, 244 may be each comprised of a piston disposed within a sleeve. It is envisioned that the piston may be coupled with the bumper 228, and the sleeve may be coupled with either the bell crank 180 or the mount 248, such that retracting of the airfoil member, or rotating of a hinged airfoil pushes the piston within the sleeve. Once the sleeve prohibits further motion of the piston, the piston and sleeve together effectuate adaptation of the shape of the airfoil member, as described herein.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. An actuator system for modifying a shape of an airfoil, comprising:
a skin overlap disposed on a surface of the airfoil and configured to allow a first portion to move relative to a second portion of the airfoil;
a drive rod coupled with a mount affixed to an interior of the first portion; and
a bumper configured to push the drive rod and the mount during movement of the airfoil, such that the first portion slides relative to the second portion, thereby modifying the shape of the airfoil.

2. The actuator system of claim 1, wherein the airfoil comprises a trailing edge flap coupled with an aircraft wing, the bumper being mounted to the aircraft wing so as to push the drive rod when the flap is retracted, thereby changing the airfoil from an initial profile to a cambered profile.

3. The actuator system of claim 2, wherein the skin overlap is disposed on an upper surface of the trailing edge flap, and wherein the lower surface of the trailing edge flap is configured to exert a continuous force in opposition to the force exerted by the drive rod while the airfoil is in the cambered profile.

4. The actuator system of claim 2, wherein the skin overlap is disposed on a lower surface of the trailing edge flap, and wherein the upper surface of the trailing edge flap is configured to exert a continuous force in opposition to the force exerted by the drive rod while the airfoil is in the cambered profile.

5. The actuator system of claim 3 or claim 4, wherein the continuous force changes the trailing edge flap from the cambered profile to the initial profile during extending of the trailing edge flap.

6. The actuator system of claim 1, wherein a bell crank is rotatably attached to an interior member of the airfoil and configured to receive an end of the drive rod, and wherein a pivot is disposed opposite of the drive rod and configured to couple the bell crank to the mount.

7. The actuator system of claim 1, wherein the actuator system is coupled with and driven by a flap drive system and a linkage system configured to extend, deflect, and retract a trailing edge flap of an aircraft.

8. The actuator system of claim 1, wherein the actuator system is configured to cooperate with a slat drive system and a linkage system that are configured to extend a slat of an aircraft.

9. The actuator system of claim 1, wherein the actuator system is configured to couple the drive rod adjacently to hinges of an airfoil member, such that rotation of the airfoil member about the hinges pushes the drive rod, thereby effectuating a shape adaptation of the airfoil member.

10. The actuator system of claim 9, wherein the airfoil member is selected from the group consisting of ailerons, horizontal stabilizers, generally hinged airfoil members, and combinations thereof.

11. A method for an actuator system to modify a shape of an airfoil, comprising:
configuring a skin overlap on a surface of the airfoil to allow a first portion to move relative to a second portion of the airfoil;
coupling a drive rod with a mount affixed to an interior of the first portion; and
positioning a bumper to push the drive rod and the mount during movement of the airfoil, such that the first portion slides relative to the second portion, thereby modifying a profile of the airfoil.

12. The method of claim 11, wherein the coupling comprises:
attaching a bell crank to an interior member of the airfoil, such that an end of the drive rod is received by the bell crank; and
linking the bell crank to the mount by way of a pivot disposed oppositely of the end of the drive rod.

13. The method of claim 12, wherein the configuring comprises forming the skin overlap in a lower surface of a tailing edge flap such that a continuous force exerted by the drive rod modifies a camber profile of the trailing edge flap by way of the bell crank and the mount, and wherein an upper surface of the trailing edge flap is configured to exert a continuous force in opposition to the force exerted by the drive rod.

14. The method of claim 11, wherein the positioning comprises mounting the bumper near the airfoil, such that the drive rod contacts the bumper during retracting of the airfoil.

15. The method of claim 11, wherein the configuring comprises forming the skin overlap in an upper surface of a trailing edge flap such that a continuous force exerted by the drive rod modifies a camber profile of the trailing edge flap, and wherein a lower surface of the trailing edge flap is configured to exert a continuous force in opposition to the force exerted by the drive rod.

16. The method of claim 11, further comprising coupling the actuator system with a flap drive system and a linkage system that are configured to extend, deflect, and retract a trailing edge flap of an aircraft.

17. The method of claim 11, further comprising coupling the actuator system with a slat drive system and a linkage system that are configured to extend a slat of an aircraft.

18. An actuator system for modifying a trailing edge portion of a flap of an aircraft wing, comprising:
a drive rod extending from a nose portion of the flap to an interior of the flap;
a bell crank rotatably attached to an interior member of the flap and configured to receive an end of the drive rod;
a pivot disposed opposite of the drive rod and configured to couple the bell crank to a mount fixed to a lower surface of the trailing edge portion;
a skin overlap configured to allow the lower surface of the trailing edge portion to slide adjacently to a lower surface of a remaining portion of the flap under the action of the drive rod; and
a bumper disposed within the aircraft wing and configured to exert a continuous force on the drive rod when the flap is moved to a retracted state.

19. The actuator system of claim 18, wherein the actuator system is configured to cooperate with a flap drive system and a linkage system that are configured to extend, deflect, and retract the flap of the aircraft wing.

20. The actuator system of claim 18, wherein the continuous force maintains a cambered profile of the trailing edge portion when the flap is in the retracted state.

21. The actuator system of claim 18, wherein the continuous force is relieved and the trailing edge portion returns to an initial profile when the flap is extended away from the aircraft wing.
